(19) United States
(12) Patent Application Publication
(10) Pub. No.: US 2026/0025890 A1
(43) Pub. Date: Jan. 22, 2026

(54) LINEAR CURRENT DRIVER AND REGULATION OF SAME

(71) Applicant: Innovations In Optics, Inc., Woburn, MA (US)

(72) Inventor: David Naviaux, Springfield, OR (US)

(21) Appl. No.: 19/276,510

(22) Filed: Jul. 22, 2025

Related U.S. Application Data
(60) Provisional application No. 63/673,985, filed on Jul. 22, 2024.

(51) Int. Cl. H05B 45/395; H05B 45/375; H05B 45/50; H05B 47/165; H05B 47/17

(52) U.S. Cl. CPC H05B 45/395; H05B 45/375; H05B 45/50; H05B 47/165; H05B 47/17

(57) ABSTRACT

A light emitting diode (LED) driving system comprises at least one linear current driver configured to regulate current to a plurality of LEDs in a multi-spectral application independently of an electrical load affected by voltage fluctuations across the LEDs; and a programmable input configured to receive a current setpoint signal from a digital-to-analog converter (DAC), which defines a target current through the LEDs. The LED driving system further comprises a programmable voltage regulator configured to output a supply voltage to the least one linear current driver that includes a saturation voltage sufficient for the at least one linear current driver to regulate the current delivered to the plurality of LEDs.

### RELATED APPLICATION

This application claims the benefit of the earlier filing date of U.S. Provisional Patent Application No. 63/673,985, filed Jul. 22, 2024 and titled “Linear Current Driver,” the content of which is incorporated herein by reference in its entirety.

### FIELD OF THE INVENTION

The invention relates to a scalable, efficient, and intelligent linear current driver system and corresponding adjustable voltage regulator tailored for precision-driven, uniform illumination in systems such as multispectral illuminators for solar simulators, battery chargers, vertical cavity surface-emitting devices (VCSELs), or other high-density light emitting diode (LED) configurations.

### BACKGROUND

Devices that convert solar energy directly into electrical power represent an important part of renewable energy technology and are being used the world over, even in space-borne applications. Such devices include solar panels which may be located on the tops of residential and commercial buildings and in fields generally referred to as solar farms. As solar cell efficiencies continue to improve and be produced in higher quantities, the need for solar simulators of high uniformity and stability increases to help researchers and developers design improved performance solar cells and panels.

Multispectral illuminators are quite popular in solar simulation because they can replicate the sun's spectral output across a wide range of wavelengths, from ultraviolet (UV) through visible to near-infrared (NIR). This is crucial for testing devices that rely on solar energy such as photovoltaic (PV) cells, under controlled and repeatable conditions. To simulate solar light, multispectral illuminators comprise combinations of LEDs, each tuned to a specific wavelength, to collectively recreate the broad and complex spectrum of sunlight.

The illuminator LEDs are typically driven by a controlled current or voltage provided by linear or switching current drivers so they emit light at the desired intensity, wavelength, and time period. Linear current drivers are preferred because they offer a much wider dynamic range as well as superior spectral stability and precision at a lower cost and higher speed, which are critical in solar simulators. They provide smooth, low-noise current control, which is essential for maintaining consistent LED output across wavelengths.

However, linear current drivers face a key challenge: they tend to be less efficient and generate more heat, especially when driving LEDs with widely varying forward voltages. This heat is caused by inefficient power conversion in the drivers and not only wastes energy but also requires valuable PCB space to address cooling requirements, which poses a design constraint. As a result, the challenge lies in maintaining tight current control while minimizing power loss and thermal footprint.

### SUMMARY

Aspects of the system and method described herein includes a family of current drivers and programmable voltage regulators that work in tandem to deliver optimized current to multi-group LED arrays. By dynamically adjusting the supply voltage based on LED forward voltage and real-time operating conditions, the system significantly reduces unnecessary voltage overhead and thermal dissipation. Some embodiments include current sink and current source drivers tailored to LED die polarity (P-down and P-up, respectively). Other embodiments include a group-level programmable voltage regulator that fine-tunes supply voltage based on saturation voltage (Vsat) and forward voltage characteristics. Other embodiments include real-time gate voltage monitoring for early failure detection. Other embodiments include an automated Vsat calibration routine that characterizes each driver's minimum regulation voltage across its output range and fits it to a predictive quadratic model.

In a particular aspect, a light emitting diode (LED) driving system comprises at least one linear current driver configured to regulate current to a plurality of LEDs in a multi-spectral application independently of an electrical load affected by voltage fluctuations across the LEDs; and a programmable input configured to receive a current setpoint signal from a digital-to-analog converter (DAC), which defines a target current through the LEDs. The LED driving system further comprises a programmable voltage regulator configured to output a supply voltage to the least one linear current driver that includes a saturation voltage sufficient for the at least one linear current driver to regulate the current delivered to the plurality of LEDs.

In another aspect, a multi-mode linear current driver system for regulating current through a plurality of light-emitting diodes (LEDs) comprises a plurality of linear current drivers, each configurable to operate in at least one of three modes, including: a current sink mode for sinking current from an LED with its anode at a positive supply rail; a P-down mode for sinking current from an LED with its anode grounded; and a P-Up current source mode for sourcing current to an LED with its cathode grounded. Each of the plurality of linear current drivers comprises: a control circuit including an operational amplifier and a regulating transistor configured to regulate current through a sense resistor based on a programmable setpoint voltage; and a saturation detection circuit monitoring a gate voltage of the regulating transistor and configured to identify fault conditions or regulation failure.

In another aspect, a method for characterizing a saturation voltage (Vsat) profile for a linear LED current driver comprises operating the LED driver across a range of output current setpoints; for each setpoint, adjusting a driver supply voltage until the driver reaches a point of regulation failure or instability; recording the minimum supply voltage at which the driver maintains stable current regulation for each output current level; storing the supply voltage values as corresponding Vsat data points indexed to current levels; and generating a voltage control profile by applying a quadratic regression to the Vsat data to model the minimum required supply voltage as a function of output current.

In another aspect, a method for calibrating a saturation voltage profile for a linear current driver regulating current to a light-emitting diode (LED) comprises disabling all current drivers in a system to establish a baseline operating state; selecting a current driver from a plurality of current drivers for calibration; iteratively applying a plurality of current setpoints to the selected current driver across a predetermined current range. For each current setpoint: methodically modifying the supply voltage provided to the current driver to identify the lowest voltage at which stable current regulation is maintained; identifying a corresponding minimum supply voltage at that current setpoint as the saturation voltage required for proper regulation; storing a value of the saturation voltage indexed to the corresponding current setpoint; repeating the calibration steps for each of the plurality of current drivers; and generating a voltage profile by applying a mathematical model to the stored saturation voltage values, wherein the voltage profile defines a minimum required supply voltage for current regulation as a function of output current.

### BRIEF DESCRIPTION OF THE DRAWINGS

The structure, operation, and methodology of the invention, together with other objects and advantages thereof, may best be understood by reading the following detailed description in connection with the drawings in which each part has an assigned numeral or label that identifies it wherever it appears in the various drawings and wherein:

FIG. 1 is a block diagram of a linear current driver system for use with a multispectral LED illuminator system, in accordance with some embodiments.

FIG. 2 shows a schematic representation the current sink driver of FIG. 1, in accordance with some embodiments.

FIG. 3 shows a schematic representation the P-down driver of FIG. 1, in accordance with some embodiments.

FIG. 4 shows a schematic representation the current source driver of FIG. 1, in accordance with some embodiments.

FIG. 5 shows a schematic representation of the voltage regulator of FIG. 1, in accordance with some embodiments.

FIG. 6 shows a schematic representation of a current sink LED group, in accordance with some embodiments.

FIG. 7 shows a schematic representation of a current source LED group, in accordance with some embodiments.

FIG. 8 shows a schematic representation of a P-down LED group, in accordance with some embodiments.

FIG. 9 shows a flow diagram of a saturation voltage characterization process, in accordance with some embodiments.

FIG. 10 is a graph showing saturation voltage characterization data for a white die of a multi-spectral array, in accordance with some embodiments.

### DETAILED DESCRIPTION

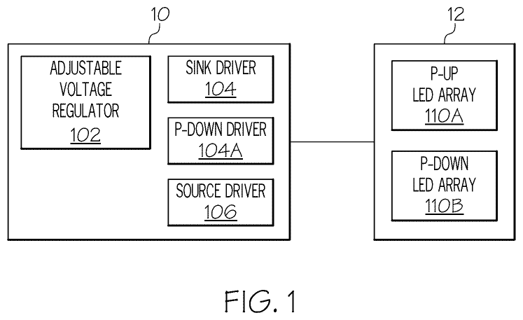

FIG. 1 illustrates a block diagram of a scalable linear current driver system 10 constructed and arranged to drive a multispectral LED module 12. The system 10 can achieve efficient, high-precision current regulation across a wide dynamic range while minimizing thermal dissipation and control complexity.

The system 10 includes a voltage regulator 102, a plurality of current sink drivers 104, and a plurality of current source drivers 106 that efficiently drive one or more multispectral LED arrays 110A, 110B (generally, 110) of an LED module 12. In some embodiments, the LED module 12 includes a multi-channel LED array 110 implemented as a metal core printed circuit board (PCB) that hosts the LEDs 110 with diverse spectral outputs. The LED module 12 is in communication with a control module of the system 10 comprising the drivers 104, 106, which in turn are configured to control an intensity of each LED 110 by precisely regulating the drive current through each LED 110.

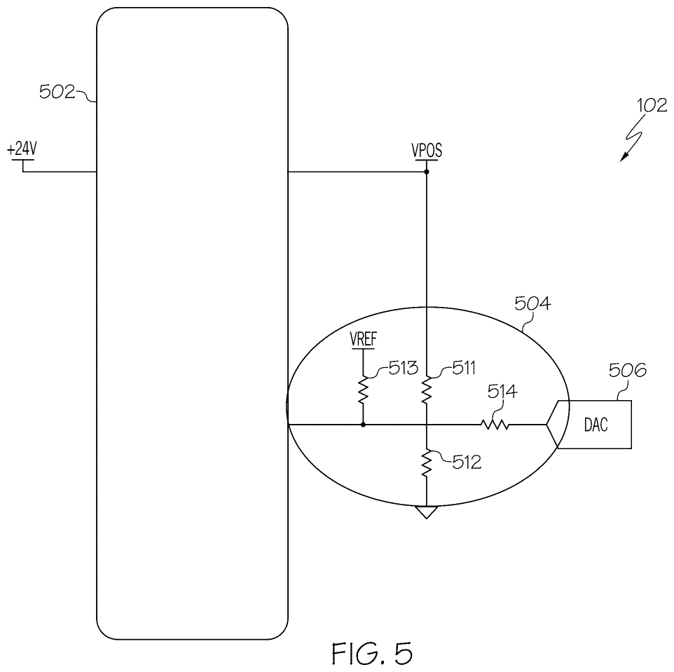

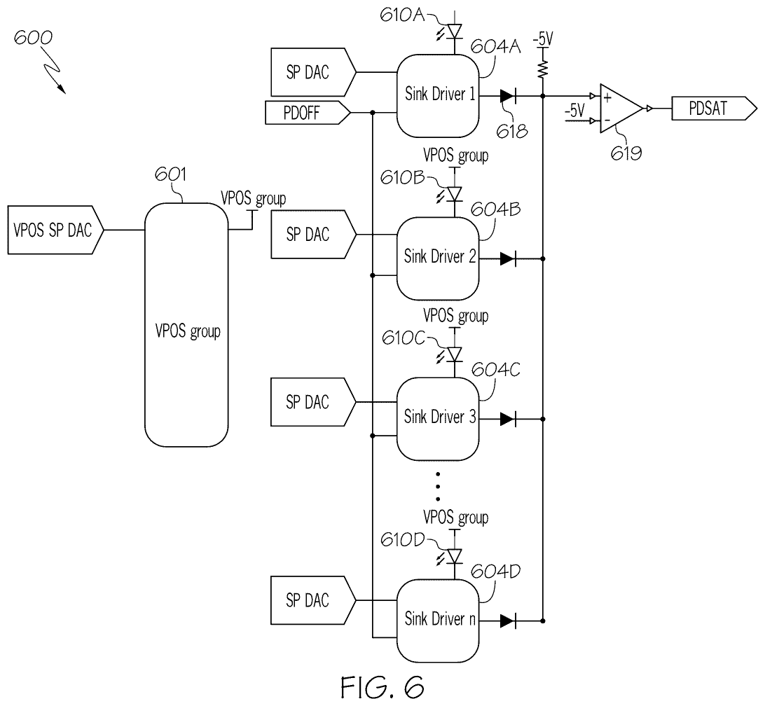

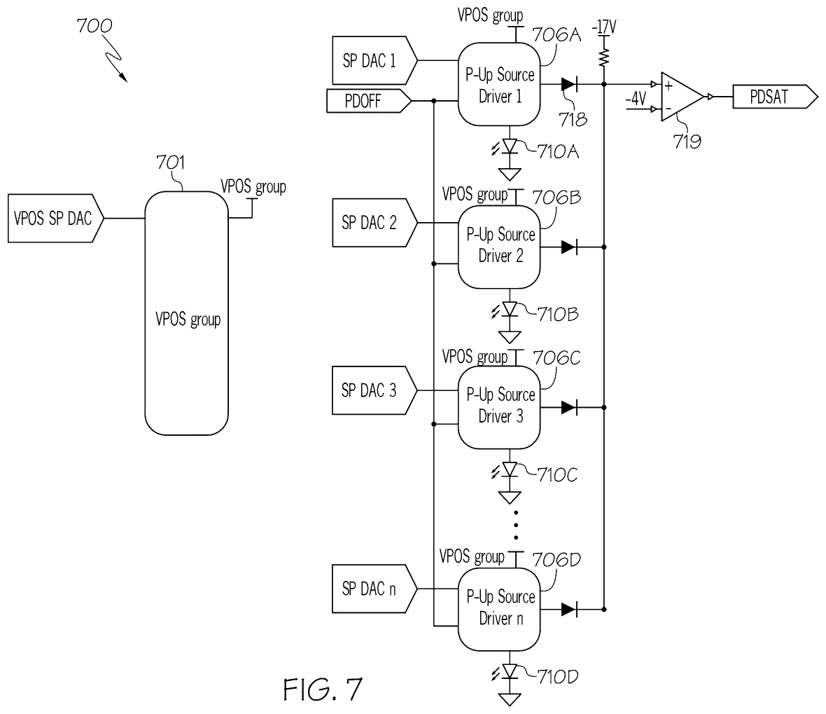

The voltage regulator 102 enhances power efficiency by dynamically adjusting a supply voltage (VPOS/VNEG) delivered to the current sink 104 and/or current source drivers 106. In some embodiments, the regulator 102 comprises a programmable buck converter controlled by a digital-to-analog converter (DAC) and a feedback network, as illustrated in FIG. 5. In some embodiments, the LED module 12 is divided into groups based on the forward voltage and drive polarity (sink or source) of the LEDs 110, as illustrated in FIGS. 6 and 7. Each group is paired with its own dedicated VPOS regulator 102. During operation, the regulator 102 continuously adjusts the supply voltage to match the needs of the group, i.e., just high enough to support current regulation and thereby minimizing heat dissipation in the driver's regulator transistor and reducing overall power loss.

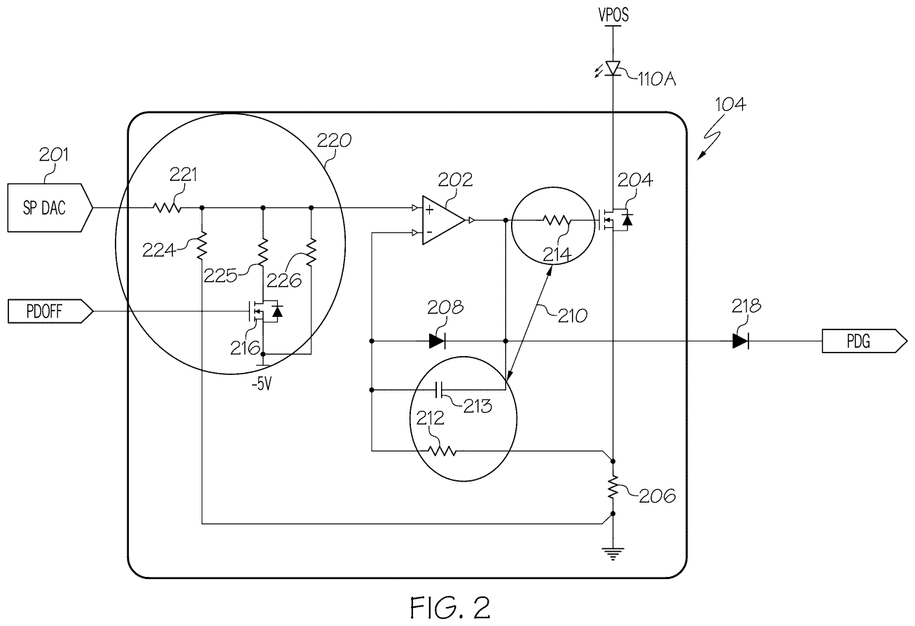

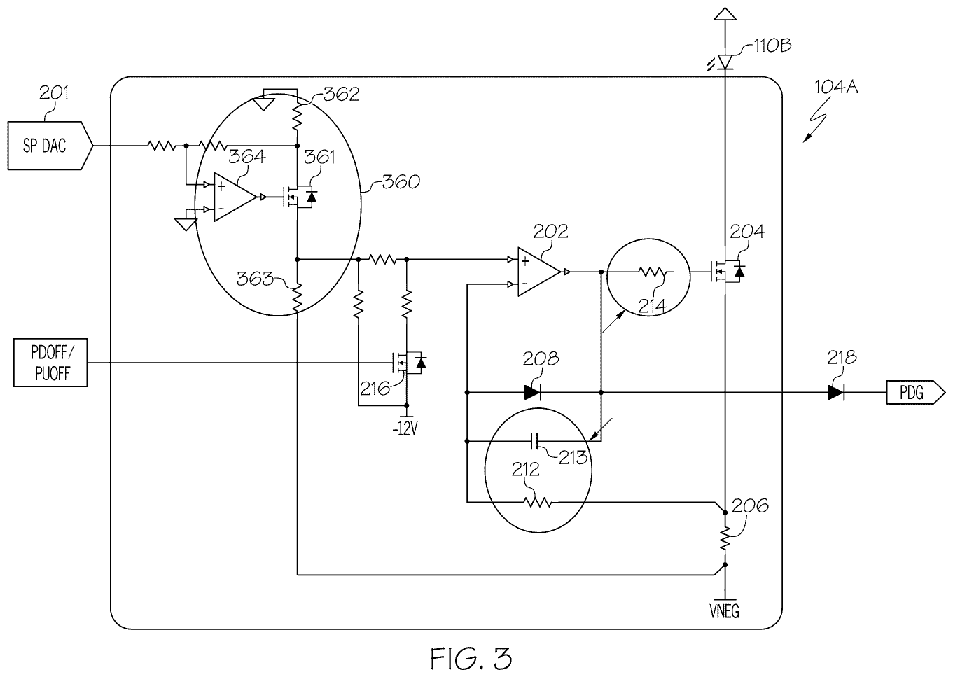

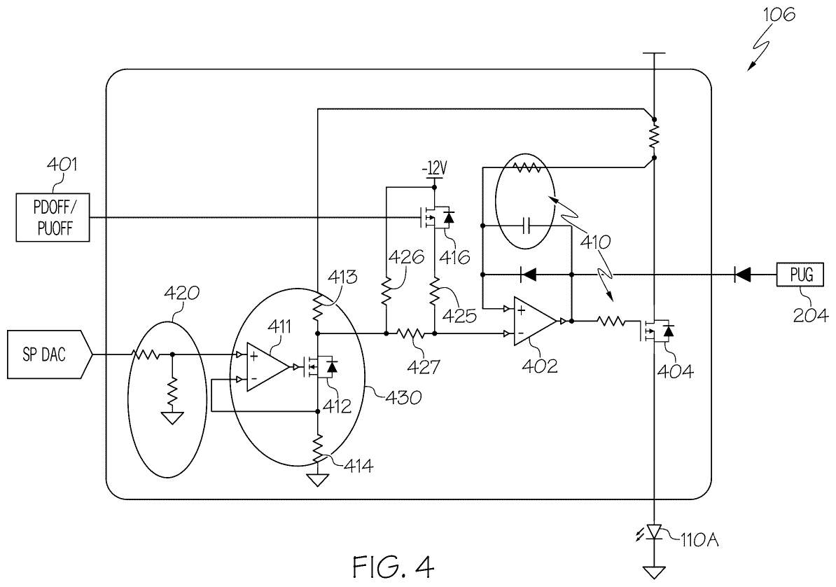

The current sink driver 104, illustrated in FIG. 2, regulates current for a group of LEDs 110A with their anodes at a positive supply rail. Similarly, the P-down driver 104A, shown in FIG. 3, is designed for grounded-anode LEDs and operates using a negative voltage rail (VNEG). As used herein, ‘P-down’ refers to an LED die with a grounded p-type region. In contrast, the current source driver 106, shown in FIG. 4, regulates current for P-up LEDs 110A, or a LED die with the p-type region facing away from the grounded substrate. As shown in FIGS. 2-4, all three driver types may incorporate a combination of operational amplifiers (op-amps), Metal-Oxide-Semiconductor Field-Effect Transistors (MOSFETs), and compensation networks to ensure accurate current regulation and fast transient response. Each driver 104, 104A, 106 can be globally disabled by one of two shared control signals (PDOFF or PUOFF). Activating both PDOFF and PUOFF will simultaneously shut off all drivers in the system. Additionally, individual drivers can be turned off by setting their respective setpoint digital-to-analog converter (SP DAC) voltage below a defined threshold (e.g., 10 mV). This dual-layer control architecture (global control and per-channel control) enables both fine-grained intensity modulation and coordinated system-wide shut down, supporting efficient and reliable operation of multispectral LED arrays

In some embodiments, the LEDs 110 of the module 12 are organized into groups based on both die polarity and forward voltage characteristics. Die polarity may include P-down configurations (grounded anode), which are driven by current sink drivers 104 or P-down drivers 104A, and P-up configurations (grounded cathode), which are driven by current source drivers 106. Within each polarity group, the LEDs 110 may be further subdivided by forward voltage to form subgroups with similar electrical characteristics. Each subgroup is assigned a dedicated VPOS regulator 102, which dynamically adjusts the supply voltage to a value just high enough for all subgroup linear current drivers to maintain proper current regulation (i.e., greater than the maximum Vsat voltage of all drivers in the subgroup). All drivers within a given subgroup receive the same optimized VPOS voltage. By tailoring the supply voltage VPOS at the group level, the system minimizes power dissipation and enables efficient thermal and electrical management across the entire LED array 110.

In some embodiments, each driver, namely, current sink 104, current source 106, or P-down 104A, includes a voltage monitoring and fault detection system. This system continuously monitors the gate voltage of the driver's regulating transistor to verify proper operation. Anomalous gate voltages such as an abnormally high gate voltage in a current sink or P-down driver 104, 104A or an abnormally low gate voltage in a current source driver 106 may be indicative of the regulating transistor attempting to regulate current but is unable to maintain a desired output. Such conditions can provide real-time diagnostic feedback on the driver's viability and regulation status. In this example, if a monitored gate voltage exceeds a predefined threshold, then the system can flag a potential fault such as an open LED, a failed regulator transistor, or another component malfunction within the driver circuit.

FIG. 2 illustrates an embodiment of a current sink driver 104 configured to regulate current through a LED with the anode connected to the power supply voltage. The driver includes an operational amplifier (op-amp) 202, a regulator transistor 204, a current sense resistor 206, a diode 208, a compensation network 210, a global signal switch 216, a driver saturation diode 218, and a resistor network 220. The op-amp 202 controls the gate of the regulator transistor 204 to maintain a current through the LED 110A that matches a target value defined by a setpoint digital-to-analog converter (SP DAC) 201. The regulator transistor 204, typically a MOSFET, serves as the primary current control element, adjusting its conduction in response to the op-amp's output to ensure precise current regulation.

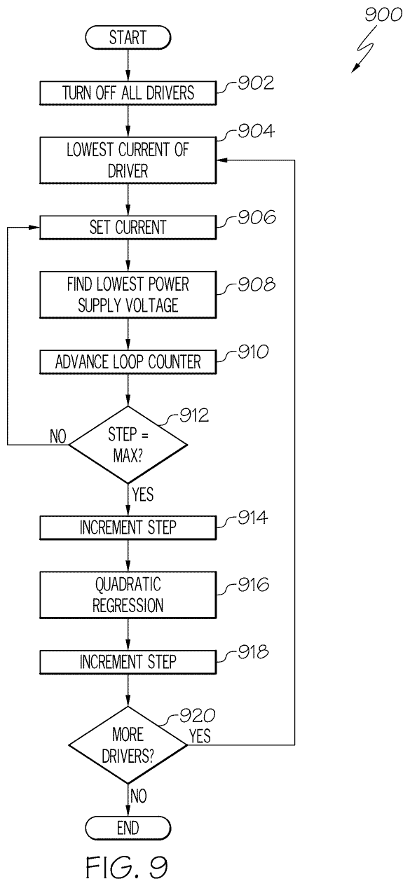

The SP DAC 201 provides an analog voltage that sets the desired LED current. This voltage is attenuated by resistors 221 and 224 and is applied to the non-inverting input of the op-amp 202, which compares it to the voltage across the current sense resistor 206, e.g., connected to the inverting input of the op-amp 202. Attenuating the voltage at the SP DAC 201 reduces power dissipation losses in the current sense resistor 206. The op-amp adjusts the gate voltage of the regulator transistor 204 accordingly to maintain the desired current. If the SP DAC voltage drops below a defined threshold (e.g., 10 mV), the op-amp 202 output turns off the regulator transistor 204, disabling the LED 110A. This allows for both fine-grained brightness control and selective channel deactivation. The op-amp 202 also provides continuous feedback and error correction by comparing the actual current through the LED 110A with the desired setpoint. If a discrepancy is detected, the op-amp 202 adjusts the gate voltage of the regulator transistor 204 to correct the current, ensuring stable and accurate regulation. To prevent overdriving the op-amp 202 output when the driver 104 is turned off, the diode 208 is connected to its inverting input. This configuration ensures that the op-amp 202 remains within its linear operating range when off, allowing for a fast recovery and immediate response when the driver 104 is re-enabled. The driver saturation diode 218 is essential for detecting when a driver is saturated during a Vsat calibration operation as illustrated in FIG. 9. A feature is that only a single diode 218 is required for each driver to detect failures at a corresponding LED.

The current sense resistor 206 measures the current flow through the LED 110 to maintain precise regulation. In doing so, the current sensor resistor 206 is positioned in series between the source of the regulator transistor 204 and ground. As current flows from the LED 110, through the regulator transistor 204, and then through the sense resistor 206 to ground, a small voltage develops across the resistor 206. The op-amp 202 in the circuit uses this voltage as feedback to maintain the desired current level, ensuring consistent LED brightness and performance.

The compensation network 210 is constructed and arranged to stabilize the driver 104 and ensures smooth dynamic response to current changes. In some embodiments, the compensation network 210 comprises an RC integrator comprising a resistor 212 and capacitor 213, and connected to an input of the op-amp 202 in the feedback loop. The compensation network 210 can introduce a dominant pole in the frequency response, slowing the loop just enough to prevent overshoot and ringing during current transitions.

The compensation network also includes a gate resistor 214 between the output of the op-amp 202 and the gate of the regulator transistor 204. The gate voltage resistor 214 can dampen high-frequency oscillations caused by parasitic capacitance and inductance, and control the rate at which the gate charges and discharges.

The global signal switch 216 provides a global shutdown capability, ensuring all drivers can turn off simultaneously when receiving a global control signal PDOFF. In some embodiments, the global signal switch 216 includes a MOSFET or the like. When the global control signal PDOFF is activated, for example, by a microcontroller (not shown) that manages the LED module 12, it activates the global signal switch 216, i.e., in an ON state, which pulls the output of the op-amp 202 low. Since the op-amp output is connected to the gate of the regulator transistor 204 through the gate voltage resistor 214, pulling the op-amp output low causes the gate voltage to drop. The low gate voltage turns the transistor 204 off because it's no longer receiving enough voltage (Vgs) of the regulator transistor 204 to stay conducting. In configurations having multiple drivers for multiple LEDs, a single PDOFF signal can disable all current sink drivers 104 simultaneously, ensuring that no current flows through any of the LEDs 110, and overriding their individual control signals. This provides a fail-safe mechanism against software or hardware faults.

Resistors 221 and 224 attenuate the SP DAC input to reduce the power dissipation in the current sense resistor 206. 220 form the driver disable circuitry. The driver can be disabled by asserting global PDOFF or individually by reducing the SP DAC output to less than 10 mV. In some embodiments, a MOSFET 216 and associated current limit resistor 225 apply a negative voltage to the non-inverting input of the op-amp 202 when PDOFF is asserted. This will result in turning off the series MOSFET 204 and thus disabling the driver output current. PDOFF assertion will simultaneously disable all Sink 104 or P-Down 104A drivers. The offset resistor 226 allows the driver to be disabled without affecting any other driver as explained in the following paragraph. The resistor 212, capacitor 213, and gate resistor 214 stabilize the control loop to form the control loop stabilizing network 210. This network stabilizes the control loop to prevent oscillations and provide a fast, clean transient response when the output current is changed or the driver is toggled on/off.

The setpoint offset resistor 226 is connected between the setpoint node (shared by resistors 221 and 226 and op-amp non-inverting input) and ground. The setpoint offset resistor 226 can generate a defined voltage offset that sets the minimum SP DAC threshold required to turn on the driver 104. When the SP DAC voltage <10 mV, the op-amp input doesn't reach the regulation threshold, and the driver 104 remains off. Resistor 226 therefore assists with maintaining a reliable off-state behavior when the DAC voltage is near zero.

The current sink driver 104 also includes a real-time fault detection system comprising the regulator transistor 204, a gate node between the gate voltage resistor 214 and the gate pin of the regulator transistor 204, and the driver saturation diode 218 that enable voltage-based failure detection. It monitors the gate voltage of the regulator transistor 204 using the driver saturation diode 218. If the gate voltage exceeds a predefined threshold, then the system can flag a potential fault such as an open LED, a failed transistor, or another malfunction and allowing for immediate diagnostic response.

FIG. 3 shows a schematic representation of the P-down driver 104A of FIG. 1, in accordance with some embodiments. The P-down driver 104A may be implemented in applications where the LEDs 110B are mounted on a common grounded substrate, such as in high-density multispectral arrays. The P-down driver 104A operates using a negative voltage rail (VNEG), since the LED anode is tied to ground. Many of the components forming the P-down driver 104A are the same as or similar to those forming the current sink driver 104 and are not described again for brevity. Some components in FIG. 3 such as the op-amp 364 are only used with the current sink driver 104. However, the current sense resistor 206 is placed between the regulator transistor 204 and VNEG, meaning it is not at ground potential. This introduces a negative common-mode voltage that varies with the programmed VNEG voltage that must be compensated for to minimize introduction of driver output current uncertainty.

In some embodiments, the P-down driver 104A includes a level-shifting translator 360, also referred to as a level-shifting inverter circuit, comprising a level-shifting transistor 361, first resistor 362, second resistor 363, and an op-amp 364. The circuit 360 inverts and shifts the SP DAC setpoint voltage into the negative domain, allowing the op-amp 364 to compare voltages within its common-mode input range. The voltage at 363 becomes a negative-domain setpoint voltage, which may be provided under control of the level-shifting transistor 361 to the non-inverting input of the regulation op-amp 202. This allows the regulation op-amp 202 to accurately compare the setpoint against the feedback from the current sense resistor 206, unaffected by the common mode voltage introduced by VNEG. In some embodiments, the level-shifting transistor 361 is a MOSFET that regulates the voltage across resistor 362 that sets a reference current common to both 362 and 363. With the voltage at one end of 363 set to VNEG, The voltage at the opposite end of 363 sets the inverted and shifted setpoint voltage applied to the non-inverting input of the regulation op-amp 202 for accurate driver output current regulation.

Both the sink driver 104 and the P-down driver 104A are designed for high thermal efficiency and a compact footprint, which offer advantages in systems utilizing large numbers of LEDs. In typical multi-spectral arrays, where numerous drivers are required, minimizing heat generation from each driver becomes critical to reducing overall PCB area. The dominant source of power loss in these linear drivers is the regulator MOSFET 204. To minimize this, the system dynamically adjusts the VNEG supply voltage to the lowest level that still ensures proper regulation, reducing heat and conserving board space.

FIG. 4 shows a schematic representation of the current source driver 106 of FIG. 1, in accordance with some embodiments. As described in FIG. 1, the current source driver 106 is designed to regulate the current in a P-up LED (anode on the top and the cathode on the bottom that is connected to GND). As shown, FIG. 4 may include an operational amplifier (or “op-amp”) 402, a regulator transistor 404, a current sense resister 406, a diode 408, a compensation network 410, a global signal MOSFET 416, a driver saturation detection diode 418 and a SP DAC attenuator 420. Many of these components are similar or identical to those used in the current sink driver 104 (FIG. 2) and the P-down driver 104A (FIG. 3).

In some embodiments, the current sense resistor 406 is placed on the high side between the source of the regulation MOSFET 404 source and VPOS rail. Because VPOS will be changed as required to minimize driver power dissipation, a differential amplifier would have to be very insensitive to these changes (i.e., it must have a very high common mode rejection ratio). For the precision required to maintain LED optical integrity, this would require an expensive integrated solution.

To address this, the driver 106 employs a special setpoint level translator 430 instead of a differential amplifier. The setpoint level translator 430 for enabling accurate current regulation because the current sense resistor 406 is on the high side (proximal the VPOS rail), rather than ground. In some embodiments, the setpoint level translator 430 includes an op-amp 411, a level-shifting transistor 412, and resistors 413 and 414, which together invert and shift the SP DAC output to be referenced against VPOS. This allows the op-amp 402 to regulate current based on a ground-referenced DAC signal, without being affected by variations in the supply voltage VPOS. Specifically, the attenuated SP DAC voltage is buffered by op-amp 411 to ensure a stable, low-impedance signal. The level-shifting transistor 312, e.g., a P-channel MOSFET, along with resistors 313 and 314, translates this signal into the VPOS domain. The resulting voltage serves as the setpoint for the main regulation loop, allowing the op-amp 402 to maintain precise current control through the LED 110 without being affected by the common mode voltage introduced by the supply voltage VPOS.

Similar to FIGS. 2 and 3, the global signal switch 416 in FIG. 3 provides global shutdown capability, ensuring all P-Up drivers turn off simultaneously when receiving a global control signal PUOFF. The driver 106 may include a multi-resistor shutdown network 425-427 that ensure the driver is off when PUOFF is applied or when the SP DAC input is below 10 mV. When the global signal switch 416 receives a global shutdown (PUOFF) signal 401, these resistors 425-427 ensure the shutdown is fast, stable, and predictable. In particular, resistor 425 applies a positive voltage greater in magnitude than the supply voltage VPOS to the non-inverting input of the regulation op-amp 402. This will prevent the series MOSFET 404 from turning on and thus shut off the driver output current to the LED. Resistor 426 continues to define the DAC voltage threshold below which the op-amp 402 treats the setpoint as “off”, e.g., less than 10 mV.

FIG. 5 shows a schematic representation of the voltage regulator 102 of FIG. 1, in accordance with some embodiments. In short, the voltage regulator 102 is constructed and arranged to generate a precise, programmable supply voltage (VPOS) for each LED group, e.g., LEDs 110 of the module 12 grouped by their forward voltage characteristics, and to minimize power loss in the linear current drivers 104, 106. By setting VPOS just above the minimum required for current regulation, the system reduces unnecessary heat dissipation, or setting VNEG to be just below the minimum required negative voltage for proper operation of P-down drivers. The LEDs 100 can also be grouped by driver type, which depends on the LED die polarity. For example, the LEDs may be grouped into a current sink group for P-down LEDs, a P-down group for anode grounded LEDs requiring a negative power supply voltage, or a current source group for P-up LEDs. Accordingly, the voltage regulator 102 can be shared across a group of either sink drivers 104 of FIG. 2 or P-Up drivers of FIG. 4. In a similar way, the programmable VNEG voltage (details are not shown due to its complexity) can be shared across a group of P-Down drivers.

As shown, the voltage regulator 102 in some embodiments includes a buck converter 502, a four-resistor feedback network 504, and a DAC input 506.

The buck converter 502 is a current-mode controlled buck converter providing for its fast transient response and stability over a wide range of output voltages. It steps down a higher input voltage to a lower, regulated VPOS. In some embodiments, the buck converter 502 includes a switching transistor, inductor, and capacitor to regulate VPOS. The transistor rapidly switches on and off to control energy transfer, while the inductor and capacitor smooth the output.

The programmable feedback network 504 allows the DAC 506 to precisely control the output voltage of the buck converter 502, which in turn sets the power rail (e.g., VPOS) for a group of LED drivers 104, 106. The feedback network 504 includes resistors 511 and 512 forming a voltage divider from the power supply voltage to ground. The midpoint of this divider connects to the buck controller's feedback pin, which regulates the output voltage. Additional resistors 513 and 514 allow the DAC 506 to inject current into the feedback node, effectively shifting the sensed voltage and adjusting the supply voltage rail accordingly. This transforms a fixed-voltage buck converter 502 into a digitally programmable power supply, enabling real-time voltage optimization for each LED group.

The DAC 506 dynamically sets the desired power rail output voltage by injecting a programmable voltage into the feedback network. The microcontroller (not shown) calculates the required DAC voltage based on the desired LED current and the driver's saturation voltage (Vsat). This ensures that the supply voltage rail (e.g., VPOS or VNEG) is just high enough to maintain regulation without excessive overhead.

The resistor values of the resistors 511-514 in the feedback network 504 are selected based on transfer equations that define how the DAC voltage injected into the feedback network translates into the specific output voltage range from the buck converter. The voltage regulator 102 may have a microcontroller (not shown) that processes a transfer function derived from the resistor network 504 to determine what DAC voltage is required for the desired output Whenever an LED driver's output current changes, e.g., due to brightness adjustment, LED switching, or pattern updates, the microcontroller can update the SP DAC voltage and recalculate the optimal supply voltage (e.g., VPOS). The regulator transistor (e.g., 204 or 404) requires a minimum voltage headroom (Vsat) to maintain control. If the supply voltage is too low, then the regulation fails. If the voltage is too high, then excess power is wasted as heat. The system dynamically adjusts the supply voltage to maintain this balance.

To ensure proper regulation, the supply voltage rail must also be updated. The driver's regulator transistor 204, 404 requires a minimum voltage headroom across its terminals to maintain control. If the supply voltage is too low, the transistor 204, 404 cannot regulate; if it's too high, excess voltage is dissipated as heat. The buck converter's microcontroller can calculate the required voltage rail and determine the corresponding DAC voltage needed to shift the feedback node of the buck converter 502. This node, formed at the junction of resistors 511-514, is where the converter 502 senses voltage to regulate against its internal reference. By adjusting the DAC voltage, the system shifts this node and causes the buck converter 502 to update its output voltage (e.g., VPOS) accordingly.

In some embodiments, this configuration permits the buck converter 502 to produce very low output voltages-even below its normal minimum, which is essential for driving low-forward-voltage LEDs like near-infrared (NIR) types that may need less than 1.0V. In doing so, the DAC input 506 can inject current into the feedback network 504 to override an internal reference voltage constraint offered by buck converts to provide a minimum output voltage. Thus, notwithstanding this inherent constraint, the overriding allows the feedback voltage to be shifted so that the converter 502 can regulate the voltage to values below its normal minimum. So, by shifting the feedback voltage, the system can allow the converter to adjust the voltage up or down without changing the internal reference.

As mentioned above, when an LED 110 needs power, the voltage regulator 102 can set the optimal voltage to minimize heat dissipation by lowering the supply voltage to the minimum required for proper LED operation, reducing excess power loss. The compensation networks 210, 310 stabilize the driver output ensuring stable current regulation.

FIG. 6 shows a schematic representation of a current sink LED group 600, in accordance with some embodiments. The current sink LED group 600 can be constructed and arranged to optimize power efficiency and fault detection. LEDs 610 within this group 600 are categorized based on their forward voltage characteristics, allowing the system to minimize the number of required VPOS regulators. For instance, in a typical multispectral illuminator with 100 LEDs spanning forward voltages from 0.8 V to 5.0 V, grouping LEDs by voltage range, such as 3-5 V for UV/blue and 1-2 V for red/NIR, enables the use of fewer, more targeted VPOS rails. This approach avoids the inefficiency of supplying all LEDs from a single high-voltage rail, which would otherwise waste power across lower-voltage LEDs. In some embodiments, the LEDs 610 are grouped by die polarity, namely, P-down or P-up, based on their physical orientation. Grouping by polarity supports structural compatibility with driver types (e.g., current sink vs. source), while grouping by forward voltage supports power optimization.

As shown in FIG. 6, each LED subgroup 610A-D is driven by a corresponding current sink driver 604A-D (collectively referred to as 604), which may be similar or identical to the current sink drivers 104 described in FIGS. 1 and 2.

To monitor driver performance, the current sink LED group 600 includes a comparator 619 that evaluates the gate voltages of all drivers 604A-D. Each driver's gate is connected to a driver diode 618, which conducts only when the gate voltage exceeds a defined threshold (e.g., +8 V). These diodes 618 are arranged in a logic OR configuration, pooling the highest gate voltage across the group to a shared node. This node is connected to the positive input of comparator 619, while the negative input is tied to a fixed reference voltage (e.g., +8 V). If any driver's gate voltage exceeds the threshold, indicating a potential fault such as an open LED or a failed transistor, the comparator 619 trips and generates a group-level fault signal. This shared monitoring approach eliminates the need for individual fault detection circuits per driver, conserving PCB space while enabling rapid fault identification. By leveraging real-time gate voltage analysis and threshold-based detection, the system ensures reliable operation and quick diagnostics across multispectral LED arrays.

FIG. 6 also highlights the role of the VPOS SP DAC (Setpoint DAC), which provides a programmable analog control voltage to a buck converter 502, e.g., described in FIG. 5). This SP DAC signal adjusts the feedback network 604 of the converter. This dynamic adjustment ensures that each LED group 600 receives a supply voltage precisely matched to the maximum Vsat of all associated Sink drivers 604 plus 0.2V to allow for LED aging and component tolerances, minimizing thermal losses and maximizing efficiency.

FIG. 7 shows a schematic representation of a current source LED group 700, in accordance with some embodiments. Similar to the current sink LED group 600 of FIG. 6, the current source LED group 700 is constructed and arranged by its LED forward voltage characteristics. However, LEDs 710 in FIG. 7 can be further grouped into current source groups 700 for regulating the current in a P-up PED polarity die. In contrast to the sink group 600 in FIG. 6, which pulls current through the LED 610 to ground, the source group 600 in FIG. 6 delivers current from above, with the regulator transistor positioned on the high side of the LED 710.

Each LED subgroup 710A-D within the current source LED group 700 is driven by a corresponding source driver 706A-D (collectively referred to as 706), which may be similar or identical to the current source drivers 106 shown in FIGS. 1 and 4. The group also includes a dedicated adjustable voltage power supply 701 and a fault detection mechanism comprising diodes 718 and a comparator 719.

To detect regulation failures, the system monitors the gate voltages of all source drivers 706 in the group. Each gate is connected to a diode 718, which conducts only when the gate voltage falls below a defined negative threshold (e.g., −4 V). These diodes are arranged in a diode-OR configuration, such that if any gate voltage drops below the threshold, the shared node connected to all diodes is pulled down. This shared node is routed to the negative input of the comparator 719, while the positive input is tied to a fixed reference voltage (e.g., −4 V). If the shared node voltage falls below the reference, the comparator 719 triggers a group-level dropout fault signal.

This configuration enables the system to detect when any driver in the group is no longer regulating properly, typically due to an undervoltage condition on VPOS relative to the driver's Vsat. By consolidating gate voltage monitoring into a single comparator per group, the design minimizes PCB complexity while ensuring rapid fault detection.

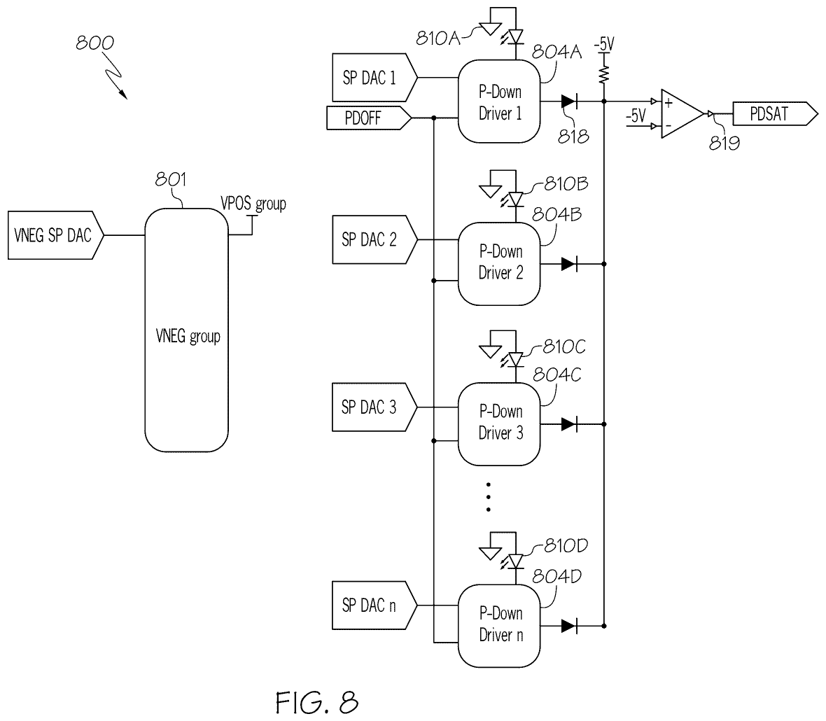

FIG. 8 shows a schematic representation of a P-down LED group 800, in accordance with some embodiments. This configuration requires the use of a negative voltage rail (VNEG) to drive current through the LED 810A-D (generally, 810). Each P-down group 800 includes a dedicated adjustable VNEG power supply 801, one linear driver 804A-D (collectively referred to as 804) per LED 810, a driver diode 818 for each driver 804, and a shared voltage comparator 819. The linear drivers 804 may be similar to or the same as the current drivers 104A of FIG. 3.

The comparator 819 monitors the gate voltages of all drivers 804 in the group 800. Each gate is connected to a diode 818 that conducts only when the gate voltage exceeds a defined positive threshold (e.g., +8 V). The diodes 818 may be arranged in a diode-OR configuration, such that the highest gate voltage among all drivers is presented to the comparator's input. If any driver 804 experiences a fault, such as an open LED or a failure in the regulation loop, the gate voltage will rise above the threshold, triggering the comparator 819. This results in a group-level fault signal, which can be used to alert the system or initiate diagnostics.

FIG. 9 shows a flow diagram of a saturation voltage characterization process 900, in accordance with some embodiments. In some embodiments, the process 900 can be performed by some or all circuits shown and described in FIGS. 1-8.

As described above, the saturation voltage (Vsat) is the minimum absolute power supply voltage required for a linear current driver to maintain proper current regulation. Vsat is not a fixed value, but varies with the driver's output current and is therefore unique to each driver. Additionally, Vsat is temperature-dependent, so characterization should be performed at the lowest expected operating temperature to ensure reliable performance under all conditions.

To optimize power efficiency and thermal performance, each current driver, e.g., shown and described in FIGS. 2-4, undergoes an offline Vsat characterization process 900. As described that saturation voltage (Vsat) is the minimum absolute power supply voltage required to maintain driver regulation. Vsat is a function of the driver output current and is unique to each driver. Vsat is also temperature dependent so Vsat characterization should always be done at the minimum normal operating temperature and is ideally suited to applications that can regulate the temperature of the LED array during the characterization process. In some embodiments, the Vsat characterization process 900 is performed automatically and typically is performed in less than one second per driver. This process determines the minimum VPOS or VNEG voltage required to maintain regulation across the driver's full output current range. The goal is to reduce excess voltage headroom, which in turn minimizes power dissipation in the driver's regulator transistor.

At step 902, all drivers are turned off so that no current is flowing through any LED channels before beginning the Vsat characterization. This provides a baseline condition by establishing a known, controlled starting point for the calibration process. Step 902 sets the initial driver index to zero, so that at step 904 the process 900 will begin with the lowest current of the first driver in the entire array of drivers so that the process 900 is performed on each driver, one at a time at each of 32 currents from the driver's minimum to maximum current.

At step 906, the target current is set to the calculated current for this Step in the current sweep. In some embodiments, the target current for the current step is calculated according to the following equation (1):

$$Amps = Step * MaxDrvrAmps ( Drvr ) / 32 + 0.01 \qquad ( 1 )$$

wherein Step is the current iteration index (0-31), MaxDrvrAmps is the maximum rated current for the driver. 0.01 (not limited thereto) is an offset that ensures the current is above the driver's turn-on threshold. The calculated value Amps is used to define the current setpoint that the DAC will output during a given iteration of the Vsat characterization loop.

Step 908 addresses the need to find the lowest absolute power supply voltage (VPOS or VNEG) that still allows the driver to maintain that current. For maximum speed, the power supply voltage is methodically adjusted using a successive approximation algorithm to find this voltage. Once found, the voltage is recorded as Vsat for this driver and current step for later evaluation in 916.

At step 910, the loop counter is advanced to the next current level in the sweep. Each “step” corresponds to a new current setpoint (e.g., 5 mA, 10 mA, 15 mA, etc.) allowing the system to characterize the driver across its full operating range.

At decision diamond 912, the system checks whether all current levels, e.g., 32 current levels, have been tested. Here, a determination is made whether the step count is equal to 32, each representing a fraction of the driver's maximum rated current. If at decision diamond 912, a determination is made that all current levels have been tested, the method 900 proceeds to step 914 where a command is generated to turn off the driver. If not, then the method 900 returns to step 906, where the system calculates the target LED current for the next higher current test step. This loop between steps 906-912 is repeated for all 32 (or other predetermined maximum number of) steps.

At step 916, after the system has stepped through all current levels for this driver, the recorded Vsat values and currents are processed using a quadratic regression technique to find the 3 coefficients, K_{A}, K_{B}, and K_{C}, in the following equation that best fit the recorded data.

$$V sat ( amps ) = {K}_{A} + {K}_{B} * \sqrt{amps} + {K}_{C} * amps \qquad ( 2 )$$

The calculated coefficients are saved to non-volatile memory so that they can be used at runtime to dynamically adjust VPOS or VNEG based on the desired current.

At step 918, the method 900 is performed on the next driver in the system. At decision diamond 920, this continues until all drivers in the array have been characterized. Once complete, the system has a full set of Vsat models, enabling dynamic voltage optimization during operation.

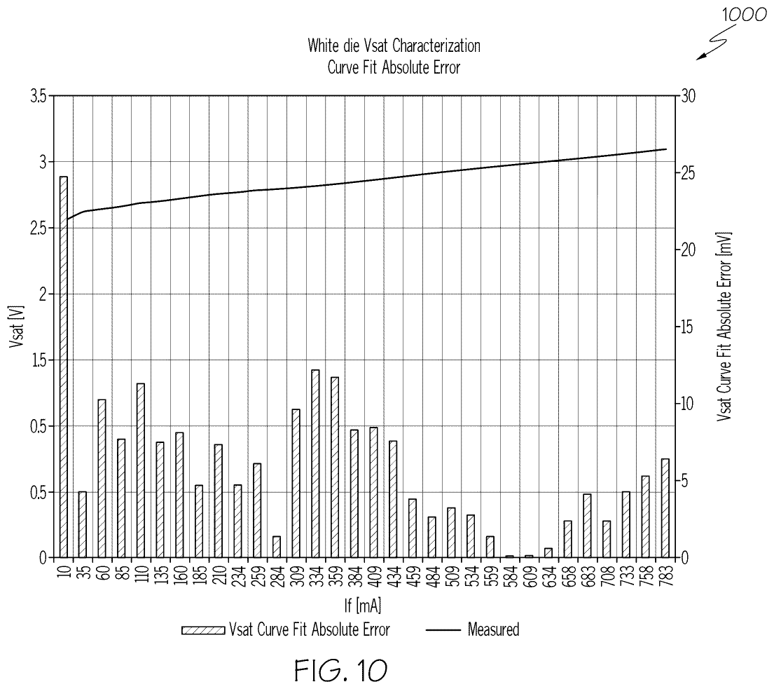

FIG. 10 is a graph 1000 showing saturation voltage (Vsat) characterization data for a white LED die of one instance of a multi-spectral array, in accordance with some embodiments. The graph 1000 plots the minimum required supply voltage (Vsat) on the vertical axis against the LED drive current on the horizontal axis.

The data points represent empirically measured Vsat values at various current levels, obtained through the automated calibration routine described in process 900. As the current increases, the required Vsat also increases, but not in a linear fashion. Instead, the curve exhibits a slight nonlinear upward trend.

To accurately model this behavior, the quadratic regression above is applied to the data, resulting in a smooth curve that fits the measured points. The bars in the graph 1000 indicate the mV error at each current step when the calculated coefficients are used to estimate Vsat. This model enables the system to dynamically calculate the optimal supply voltage for any given current during runtime, ensuring that each driver operates with just enough voltage headroom to maintain regulation. By knowing exactly how much supply voltage is needed at each current, one can dynamically adjust the supply to avoid wasting power across the regulator transistor 204, 404. The graph 1000 demonstrates how per-channel calibration enables precise, efficient power delivery across a wide range of operating conditions.

What is claimed is:

1. A light emitting diode (LED) driving system, comprising:
at least one linear current driver configured to regulate current to a plurality of LEDs in a multi-spectral application independently of an electrical load affected by voltage fluctuations across the LEDs; and
a programmable input configured to receive a current setpoint signal from a digital-to-analog converter (DAC), which defines a target current through the LEDs, the LED driving system further comprising:
a programmable voltage regulator configured to output a supply voltage to the least one linear current driver that includes a saturation voltage sufficient for the at least one linear current driver to regulate the current delivered to the plurality of LEDs.

2. The LED driving system of claim 1, wherein the at least one current driver includes at least one of a current sink driver, a P-down driver, and a P-Up current source driver.

3. The LED driving system of claim 1, wherein the at least one linear current driver comprises:
a current sense resistor in electrical communication with the LEDs to measure an actual current flowing through the LEDs and generate a voltage proportional to the actual current;
a regulator transistor in series with the current sense resistor and the LEDs to regulate the current through the LEDs;
an operational amplifier having a non-inverting input that receives setpoint voltage of the current setpoint signal and an inverting input that receives the voltage generated by the current sensor resistor for comparison to the setpoint voltage to control a gate voltage of the regulator transistor and maintain the actual current to be at a predetermined threshold with respect to the target current, wherein the regulator transistor regulates the current through the LEDs in response to the gate voltage.

4. The LED driving system of claim 3, wherein the at least one linear current driver includes a current sink driver, comprising:
a compensation network including a resistor-capacitor pair coupled to the operational amplifier;
a diode coupled to the inverting input of the operational amplifier to prevent saturation during off-state conditions;
a gate resistor coupled between the operational amplifier output and the gate of the regulator transistor to dampen high-frequency oscillations.

5. The LED driving system of claim 3, wherein the at least one linear current driver includes a P-down driver, comprising:
a negative voltage supply configured to source current through an LED having its anode connected to ground;
the regulator transistor coupled between the LED cathode and the negative voltage supply, and configured to regulate current through the LED;
the current sense resistor positioned between the regulator transistor and the negative voltage supply to measure the actual current;
a level-shifting circuit configured to invert and translate a setpoint voltage of the current setpoint signal into a negative voltage domain;
the operational amplifier for receiving and processing the level-shifted setpoint voltage to control the gate of the regulator transistor to maintain the desired current.

6. The LED driving system of claim 3, wherein the at least one linear current driver includes a P-Up current source driver, comprising:
the regulator transistor coupled in series with the current sense resistor and an LED, wherein the transistor is positioned on the high side of the LED and configured to source current from a positive voltage rail (VPOS);
a setpoint level translator configured to shift the current setpoint signal into a VPOS voltage domain; and
the operational amplifier configured to compare the translated setpoint voltage to a voltage across the current sense resistor and to control the gate of the regulator transistor to maintain a desired current through the LED.

7. The LED driving system of claim 1, wherein the programmable voltage regulator is coupled to the LEDs according to a grouping of the LEDs based on at least one of forward voltage characteristic requirements of the LEDs and LED die polarity type.

8. The LED driving system of claim 7, wherein each group of the grouping of the LEDs comprising:
a comparator configured to monitor the highest gate voltage among the group's drivers, wherein a comparator output exceeding a preset gate threshold indicates an open LED or driver fault.

9. The LED driving system of claim 7, wherein the LEDs are grouped into one or more P-down LED groups, each P-down LED group comprising:
a shared negative voltage supply and a comparator configured to monitor the gate voltage of the group's drivers, wherein the comparator asserts a fault condition if any gate voltage exceeds a defined threshold.

10. The LED driving system of claim 7, wherein said LEDs are grouped into one or more current source LED groups, each comprising:
a comparator configured to monitor gate voltages used for forcing the current to the LEDs, wherein a gate voltage of the gate voltages below a preset negative threshold is indicative of a fault condition.

11. The LED driving system of claim 1, further comprising a calibration mechanism configured to determine a minimum power supply voltage required for the least one linear current driver to maintain a current regulation across a range of current values and to generate a voltage control profile for use in adjusting the saturation voltage applied to a power supply rail of the at least one linear current driver.

12. The LED driving system of claim 1, wherein the calibration mechanism is configured to perform an offline characterization process that:
measures saturation voltages across the output current range of each linear current driver; and
stores the resulting data in nonvolatile memory indexed to individual LED-driver pairs.

13. The LED driving system of claim 12, wherein the calibration mechanism is further configured to apply a quadratic regression to the stored saturation voltage data to generate a Vsat characterization model.

14. The LED driving system of claim 1, wherein the voltage-adjustable power regulator comprises:
a buck topology converter controlled by a resistive network and a precision DAC, wherein the resistive network is configured to produce programmable voltage scaling over a desired output range including sub-specification voltages.

15. The LED driving system of claim 1, further comprising a global shutdown control mechanism configured to override the current setpoint signal from the DAC and disable the at least one linear current driver, the global shutdown control mechanism processing a shared global control signal output from an external controller managing the plurality of LED to disable the at least one linear current driver.

16. A multi-mode linear current driver system for regulating current through a plurality of light-emitting diodes (LEDs), the system comprising:
a plurality of linear current drivers, each configurable to operate in at least one of three modes, including:
a current sink mode for sinking current from an LED having an anode at a positive supply rail;
a P-down mode for sinking current from an LED having an anode grounded; and
a P-Up current source mode for sourcing current to an LED having a cathode grounded, wherein each of the plurality of linear current drivers comprises:
a control circuit including an operational amplifier and a regulating transistor configured to regulate current through a sense resistor based on a programmable setpoint voltage; and
a saturation detection circuit monitoring a gate voltage of the regulating transistor and configured to identify fault conditions or regulation failure.

17. The multi-mode linear current driver system of claim 16, wherein the each of the linear current drivers further comprises:
a compensation network configured to stabilize driver performance during transient events;
a diode arrangement to prevent operational amplifier saturation during off states, thereby ensuring fast activation response;
a programmable power supply coupled to each driver or driver group, wherein the supply voltage is dynamically adjusted based on a pre-characterized minimum saturation voltage (Vsat) profile as a function of drive current for that specific mode.

18. The multi-mode linear current driver system of claim 16, wherein the each of the linear current drivers further comprises:
a calibration engine operable to execute an offline characterization routine that measures Vsat across a range of drive currents for each driver in its corresponding mode, and stores a model of the resulting data.

19. The multi-mode linear current driver system of claim 16, wherein the each of the linear current drivers further comprises:
a fault detection subsystem comprising comparators configured to detect deviations in FET gate voltage from predetermined limits and signal an alert condition for any non-compliant driver.

20. A method for calibrating a saturation voltage profile for a linear current driver regulating current to a light-emitting diode (LED), the method comprising:
disabling all current drivers in a system to establish a baseline operating state;
selecting a current driver from a plurality of current drivers for calibration;
iteratively applying a plurality of current setpoints to the selected current driver across a predetermined current range;
for each current setpoint:
methodically modifying the supply voltage provided to the current driver to identify the lowest voltage at which stable current regulation is maintained;
identifying a corresponding minimum supply voltage at that current setpoint as the saturation voltage required for proper regulation; and
storing a value of the saturation voltage indexed to the corresponding current setpoint;
repeating the calibration steps for each of the plurality of current drivers; and
generating a voltage profile by applying a mathematical model to the stored saturation voltage values, wherein the voltage profile defines a minimum required supply voltage for current regulation as a function of output current.
